(19) United States
(12) Patent Application Publication
(10) Pub. No.: US 2007/0265554 A1
(43) Pub. Date: Nov. 15, 2007

(54) PORTABLE MASSAGE DEVICE AND METHOD OF USE

(76) Inventor: Nicholas Brusca, West Palm Beach, FL (US)

Correspondence Address: JOHN C. SMITH, ESQ., 2499 GLADES ROAD, SUITE 113, BOCA RATON, FL, 33431, US

(21) Appl. No.: 11/559,578

(22) Filed: Nov. 14, 2006

Related U.S. Application Data
(60) Provisional application No. 60/767,519, filed on May 9, 2006.

(51) Int. Cl. A61H 1/00

(52) U.S. Cl. 601/49; 601/46

(57) ABSTRACT

A foldable battery-powered massage device. The device can be remote-controlled and used in conjunction with chairs, vehicle seats, wheelchairs, beds, aircraft seats, arena seats, etc. A central flexible support surface includes electrically powered vibrating massage elements which provide therapy for the portion of an individual's body that they are applied to. Power is supplied by a removable battery which is secured to a sleeve on the flexible surface. An optional handheld remote control is also provided to allow the user to conveniently control activation, deactivation, speed, the portions of the support surface which are activated, etc.

### CROSS-REFERENCE TO RELATED APPLICATIONS

This application is related to, and claims the benefit of, the provisional patent application entitled “Portable Massage Device”, filed May 9, 2006, bearing U.S. Ser. No. 60/767,519 and naming Nicholas Brusca, the named inventor herein, as sole inventor, the contents of which is specifically incorporated by reference herein in its entirety.

### BACKGROUND OF THE INVENTION

1. Technical Field

The present invention relates to therapeutic massage devices. In particular, it relates to a portable massage device that can be used in combination with an aircraft seats, automobile seats, conventional furniture, beds, etc. The device can be used on an individual's back, legs, arms, shoulders, etc. Further, the device can be used in a variety of positions, including sitting, prone, etc. It further relates to a method for providing temporary use of the portable massage device in a variety of transportation and public use areas.

2. Background

A variety of electromechanical massage devices have been used to provide massage therapy. One type of massage device is a massager that is incorporated into a conventional chair. This type of device is typically an integral part of, or attached to, the back of the chair and provides therapy for an individual's back at a fixed location, such as their home or office. Examples of this type of massager are illustrated in U.S. Pat. No. 5,653,679 to Belanchi, U.S. Pat. No. 6,443,917 to Canto, U.S. Pat. No. 6,485,443 to Garth, and U.S. Pat. No. 6,916,300 to Hester et al. This type of device has a disadvantage in that it is not portable, and therefore, it is of no value to a traveler.

Another type of massage device is similar to the foregoing, but is incorporated into the seat of a vehicle. This type of device typically is an integral part of the automobile seat, or is custom fit for a particular seat. Likewise, power is generally supplied by the vehicle battery. Examples of this type of massager are illustrated in U.S. Pat. No. 5,029,939 to to Smith et al., and U.S. Pat. No. 5,135,282 to Pappers. While these devices work well for their intended purposes, they not only are not portable, but since they are an integral part of the automobile, it must be transferred to the purchaser of the automobile even though they may be in perfect working order. As a result, the original owner must purchase a new massager with the new automobile.

Handheld massage devices have also been developed. These are typically small devices, and are only useful for treating a small portion of the body. Examples of handheld massagers are illustrated in U.S. Pat. No. 6,332,873 to Naruse et al., and U.S. Pat. No. 6,478,755 to Young. These devices are typically designed to massage a particular part of an individuals body, and are inconvenient to carry.

Special-purpose devices have also been developed. For example, massaging bed rest cushions have been developed for individuals were confined to bed for extended periods. An example of this is the bed rest cushion illustrated in U.S. Pat. No. 5,895,365 to Tomlinson.

Another concern of many companies which cater to travelers and patrons of public events is the need to generate sufficient revenues to profitably run their businesses. It would be desirable to have an additional service that many varying types of business activities could provide which would augment their primary income while simultaneously improving their customers' enjoyment of their services. In particular, it would be desirable to have a method of improving customer comfort and therefore improving customer enjoyment of a trip or event.

It would be desirable to have a massage device which can be used for small areas on the body, or on large areas such as the back or legs, which can be used with conventional chairs or automobile seats, which can be used in a sitting or prone position, and which can be folded into a compact storage configuration for easy transport; it would be desirable to have a portable massage device that could be powered by one or more power sources, including replaceable battery units which would provide extended use; and it would be desirable to have the method of providing such devices to individuals such that the massager is available for multiple leg trips, for multiple transportation vehicle types, for use in public events, etc.

### SUMMARY OF THE INVENTION

The present invention provides a foldable and portable massage device with a battery and an optional remote-control which can be used in conjunction with chairs, vehicle seats, wheelchairs, beds, aircraft seats, arena seats, etc. A central flexible support surface includes electrically powered vibrating massage elements which provide therapy for the portion of an individual's body that they are applied to. Power is supplied by a removable battery which is secured to a sleeve on the flexible surface. An optional handheld remote control is also provided to allow the user to conveniently control activation, deactivation, speed, the portions of the support surface which are activated, etc.

The present invention also provides a method of commercially distributing the foldable and portable massage device such that it is available to travelers or patrons of public events on demand. The massage devices are provided as rental devices to travelers on public transportation vehicles (e.g., airplanes, trains, buses, ships, etc.). In addition, the massage devices may be provided as rental devices that public events (e.g., theaters, sports arenas, etc.) or as rental devices for personal use by wheelchair users, handicapped individuals, etc.

### BRIEF DESCRIPTION OF THE DRAWINGS

FIG. 1 is an illustration of a preferred embodiment of the portable massager. This figure illustrates the portable massager, and the sleeves designed to hold the battery and an optional remote-control.

FIG. 2 is an illustration of a preferred embodiment of a portable battery with electrical connector for electrical attachment to the electrical vibrating elements of the portable massager device.

FIG. 3A is a side cutaway view of the portable massager installed on an aircraft seat. This view illustrates the portable massager with a battery sleeve.

FIG. 3B is a side cutaway view of the portable massager installed on an aircraft seat with a power cable connected to a power outlet in the seat.

FIG. 4A illustrates a side view of a preferred embodiment of the portable massager in the closed (rolled up) configuration.

FIG. 4B illustrates an end view of the preferred embodiment of portable massager in the closed (rolled up) configuration.

### DESCRIPTION OF THE PREFERRED EMBODIMENT

Prior to a detailed discussion of the figures, a general overview of the portable massaging device will be presented. The portable massaging device provides a flexible support surface which has a flexible support with integral vibrating massaging elements. The device is intended to be used as a portable massaging device that can be used with a variety of devices, such as seats, vehicles, beds, wheelchairs, etc.

The device further includes storage sleeves to hold a battery, and an optional remote-control. Portable back massager is powered by a battery. Preferably, the battery is a lithium-ion battery. However, any suitable alternative battery can be used. When available, the portable back massager can also be powered by alternative power sources. For example, 110 volt power can be used when the portable back massager is used in the home or other location where such power is available. Likewise, and adapter can be used to take advantage of available power in vehicles by using automobile cigarette lighter adapter's. In the situation where the portable massager is rented (such as on an aircraft, other public transportation vehicle, or public facility), the portable massager would preferably have several available power sources. Ideally, the battery would not be necessary. Instead, power could be supplied to each passenger seat and a simple power cord could be run from the passenger seat to the power connector on the back massager. This eliminates the need to carry batteries, and reduces the cost of the device. Further, if a convenient method of providing power outlets is not available, such as on older aircraft, the battery packs would be an alternative power source to avoid having to retrofit aircraft. In the case where batteries are used, it would be useful to have additional batteries that could be charged when not in use, and swapped with depleted batteries in flight.

An advantage of providing multiple ways to use available power sources, is that a user has greater flexibility and mobility. A particular advantage of using a battery power supply is that it expands the potential areas of use for the device. The battery power opens new commercial markets because it allows use in heretofore unavailable commercial areas. For example, it opens new commercial opportunities for rentals or sales for arenas, wheelchairs, medical use, aircraft passenger seats or airport rentals, train trips, bus trips, rental cars, lounge chairs in resorts, stadium seats for sports or entertainment events, etc.

Likewise, the availability and use of conventional power outlets, or special-purpose power outlets, allows that individual to use portable massager for extended periods of time in a wide variety of circumstances. For example, if a standardized outlet connection is used, the device can be used in a wide variety of applications without the burden of carrying a battery. This would allow applications such as airline, bus, or train seats to provide power outlets as either a courtesy for passengers carrying their own portable massager, or as a way to facilitate the rental of portable massagers to passengers. Likewise, the provision of standardized outlets also allows portable massagers to be rented for use in other venues, such as in hospitals, as an accessory device for wheelchairs, as a convenience device for use in theme parks, sports arenas, music concerts, etc. Of course, the battery-powered version can be used in any of these environments. However, if the massager is provided as a rental item, there are significant advantages, both in terms of equipment costs and storage requirements, to the elimination of the need to provide a battery for each massager.

For ease of discussion, the method of using the portable massager will be discussed in terms of its use in the airline industry. However those skilled in the art will recognize that rental systems for the portable massager can be used in many industries, such as the transportation industry, as well as many venues, such as sports arenas and stadiums, concert halls, etc. The following is an example of one way in which the portable massager may be used. Due to its portable nature, a rental program can be initiated which would allow airlines to rent the portable massager to passengers while they are on board the aircraft. This provides passengers with stress relief during long flights. Stress relief is only one benefit provided to travelers by the portable massager. More serious health problems can be created by prolonged sitting. In particular, thrombosis can occur when individuals are sitting for hours at a time among flights. The portable massager improves circulation and helps to avoid this potentially dangerous problem. Yet another potential benefit of the portable massager is that by increasing blood circulation, it may help to maintain metabolism at a higher level.

Another advantage provided by a rental program is that it allows the device to be marketed less expensively. In particular, in an environment such as an aircraft, the battery can be eliminated. Electrical output can be provided for each of the seats in the aircraft. In this configuration, a conventional wire and plug can supply electrical power directly to the massager. Those skilled in the art will recognize that any suitable voltage, frequency, and our levels can be used. This provides advantages for the aircraft owner in that it reduces the cost of the individual devices because the battery is not needed, and greatly improves storage of the devices on the aircraft because of the elimination of the battery.

The device is designed to be folded into a compact storage configuration, which allows individuals to take it with them when traveling, and to use it in a variety of situations. In the case of aircraft, foldable or rollable massagers can be stored on the aircraft and rented to any passenger who requests it. As noted above, in regard to the discussion of the massager using a direct connection to a power source other than a battery, the ability to attach to an outlet power source reduces the space required to store the massagers on the aircraft. Even if the battery is used, it can be stored more efficiently if detached from the massager.

Having discussed the features and advantages of the invention in general, we turn now to a more detailed discussion of the figures.

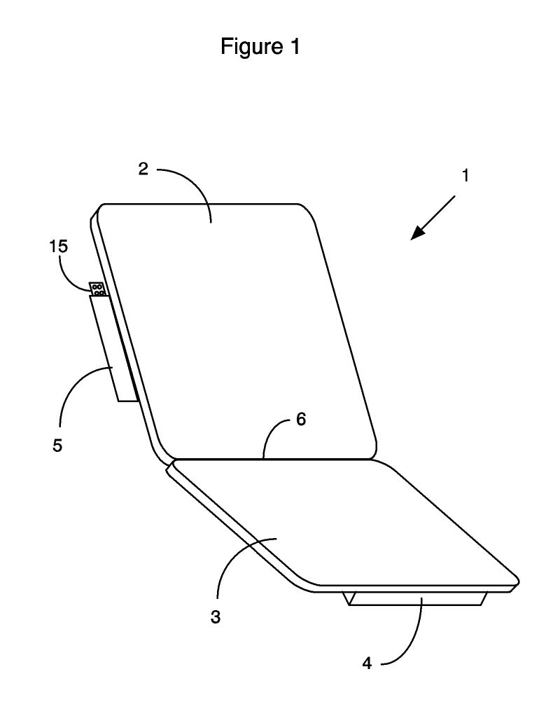

In FIG. 1, a preferred embodiment of the portable massage device 1 is shown. This figure shows the support surface which is comprised of upper segment 2 and lower segment 3. Upper and lower segments 2-3 are secured together at seam 6. Those skilled in the art will recognize that seam 6 is optional. The support surface is intended to be sufficiently flexible to allow it to be rolled or folded for easy transport or storage.

The support surface contains internal vibrating massage elements (not shown) which provide the variation in pressure used during treatment. Vibrating massage elements are well-known in the art and do not need further the discussion herein.

In the preferred embodiment, the surface material of the portable massager 1 is a poly-nylon blend fabric. However, those skilled in the art will recognize that any suitable material can be used, provided it has desired qualities such as durability, washability, comfort to the touch, an adequate airflow (“breathing”), etc.

Optionally, an internal heater can be used to provide heat in addition to the massage. This may be particularly advantageous when traveling through areas in colder climates. Of course, this optional feature would be more effective where a continuous source of power is available.

While any suitable battery can be used, it has been found that a 12 v/1800 mAH lithium-ion rechargeable battery is effective. The preferred battery has no memory effect, produces a 16 v 2.2 A output, and a 100-240 v 1.0 A-0.55 A input.

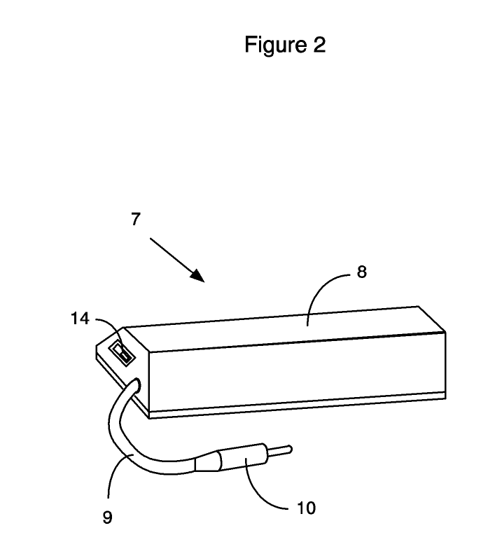

Also shown in this figure is support sleeve 4 which is used to hold removable battery power supply 7 (shown below in FIG. 2). Sleeve 4 is designed to snugly hold removable battery power supply 7 during use and may also be used to secure and storage.

Remote-control storage sleeve 5 is used to store an optional remote-control 15 which is used to control operation of the vibrating massage elements. Preferably, the remote-control 15 is a wireless device. However, it can also be hardwired to the portable massager 1.

FIG. 2 illustrates a perspective view of the battery 7. The body 8 of the battery 7 has a power cord 9 which extends out work outward from the body 8. Power plug is attached to the end of power cord 9. Also shown is optional power switch 14. In the figure, optional power switch 14 is illustrated as an integral component of battery 7. However, it can be implemented in any convenient manner. For example, the switch 14 can also be implemented as a component of the upper or lower segments 2-3, as a part of the remote-control 15, or can be eliminated entirely. The power switch 14 is not used, then the portable massager 1 would automatically turn on when power is applied.

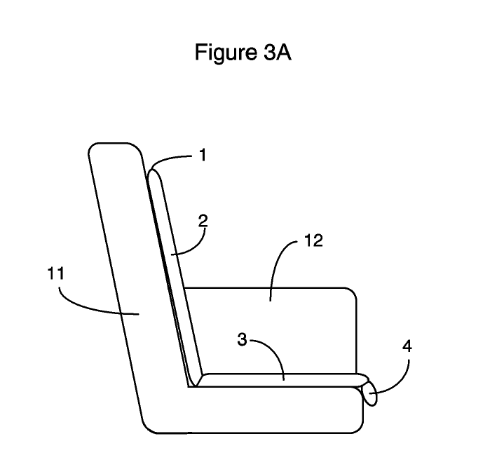

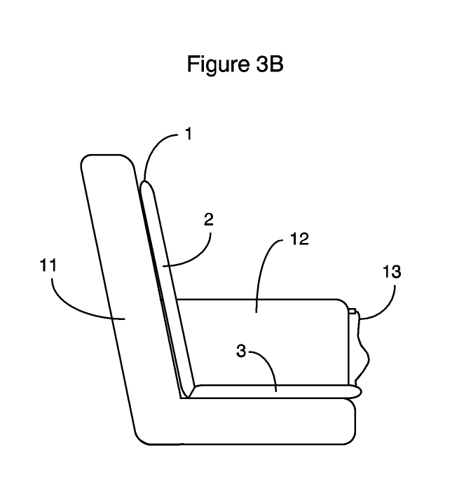

FIG. 3A is a side cutaway view of the portable massager 1 installed on an aircraft seat 11. This view illustrates the portable massager 1 with upper segment 2, lower segment 3, and a battery sleeve 4. Also shown in this figure is armrest 12 which is a component the aircraft seat 11. For ease of illustration, only one armrest 12 is shown. In the preferred embodiment, the portable massager 1 is sized such that it can fit in any standard commercial aircraft seat 11.

FIG. 3B is a side cutaway view of an alternative preferred embodiment of the portable massager 1 installed on an aircraft seat 11 with a power cable 13 connected to a power outlet in the aircraft seat 11. For ease of discussion, in FIGS. 3A-B, the invention has been described in connection with an aircraft seat 11. However, those skilled in the art will recognize that invention can be used in connection with any type of vehicle.

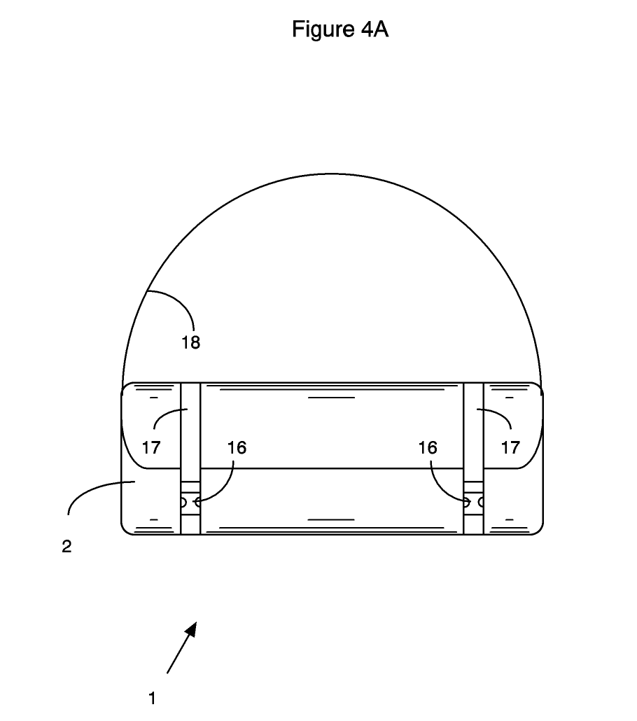

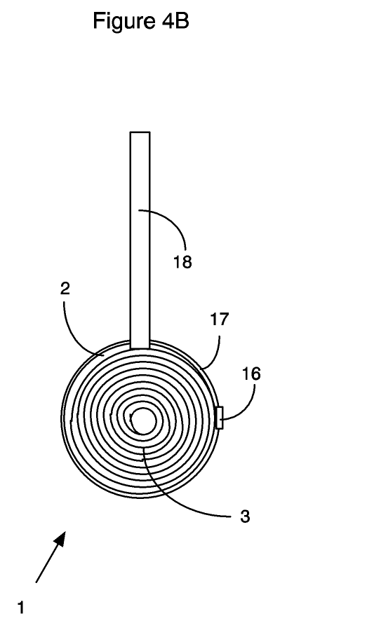

FIG. 4A illustrates a side view of a preferred embodiment of the portable massager 1 in the closed (rolled up) configuration. In the close configuration, portable massager 1 is moved into a very compact cylindrical configuration. In this configuration, portable massager 1 occupies a minimum amount of space. Two retaining straps 17, with to quick disconnect clips 16, are used to secure the portable massager 1 in the closed configuration. Also shown this figure is shoulder strap 18 which is attached to the distal and proximal ends on the portable massager 1, when in the closed configuration, and used to conveniently carry the portable massager 1 from one location to another.

FIG. 4B illustrates an end view of the preferred embodiment of portable massager 1 in the closed (rolled up) configuration. This view illustrates the upper and lower segments 2-3 rolled into a compact cylindrical form and held by retaining straps 17 and quick disconnect clips 16. In addition, shoulder strap 18 is also shown. This configuration allows the user to conveniently carry the portable massager 1 from one location to another.

There are alternative methods by which a facility may provide a user the ability to use the portable massager 1. The first situation is where the user rents a portable massager 1 from the facility operator. In this situation, the portable massager 1 may be battery-operated or powered from a fixed power outlet. The facility operator may rent the device for single event, such as an airplane flight, or for multiple events, such as multi-leg airplane flight. In this situation, the user can carry the same portable massager 1 from gate to gate, or use different portable massager 1 which are permanently stored on the aircraft. Alternatively, a facility operator may provide the ability of the user to rent a portable massager 1 for an entire trip. In this situation, the issue may obtain a portable massager 1 at the terminal, use it on the plane, take it with him for use on a rental car after arrival, use it at a hotel, use it on the return flight, and turn it in at a terminal once the trip is complete. Of course this will allow many combinations insofar as use is concerned. The user may want to rent the device for only one flight leg of a trip, for the complete flight, or for the entire round trip. The facility operator will charge appropriately for the length of time and nature of use required by the user. In the event that the nature of the trip changes, the charges can be adjusted to reflect the changes.

In addition to rental for trips, the device can also be rented for other activities, such as physical therapy or for extended use in wheelchairs, in the home, etc. When individuals attend public events, such as the theater, sporting events, or even more mundane activities such as sitting for extended times in a terminal between aircraft connecting flights, they may spend extended periods of time sitting in an immobile position. In addition to lack of comfort, extended sitting for long periods may cause physical problems for individuals. A significant advantage of the portable massager rental system described herein is that it allows an individual to temporarily purchase the right to use a portable massager 1 which can improve the individuals comfort, and by improving circulation, also avoid health problems which may occur from extended periods of sitting.

Providing portable massagers 1 over multiple legs of a trip, as well as for extended periods of time, can easily be controlled through a computerized rental or reservation system. For example, when making travel reservations, the carrier needs only to know when the passenger desires to have the use of the portable massager 1. The computer will automatically make arrangements for the availability of portable massager 1 at the appropriate points during the trip.

An advantage in the invention is that the carrier's reservation computer can arrange for the acquisition or return of a portable massager 1 at its own facility or at the facility of an associated carrier. In the travel industry, multiple types of carriers cooperate with one another. For example, tourists visiting Alaska may travel by aircraft to Seattle, and once in Seattle board a cruise ship to Alaska. Once in Alaska, tours may leave the cruise ship and take a train or bus to the interior of Alaska. On the return trip, the tourist would typically return home using all these transportation systems in reverse order. During the trip, a tourist may also be using several types of hotel, motel, and/or bed and breakfast accommodations. Rather than arranging for many rentals at different locations, the carrier's reservation computer can provide for the use of a single portable massager 1, or for several portable massager's 1 at specific points along the journey. The carrier's reservation computer provides a single payment which is made on reservation, the traveler can inconveniently have access to a portable massager 1 during the many legs of the trip. Preferably, if the traveler decides to alter his plans, the availability of a portable massager 1 can be changed during the trip. The associated carrier merely communicates to the carrier's reservation computer the change in plans, and the appropriate change to the user's invoice is made. As can be seen, the system provides a dynamic method of controlling access to the use of a portable massager 1 and many types of carriers, and many types of lodging facilities with a single resignation which controls supplying portable massagers throughout the trip. In addition, the system also provides for the use and availability of additional batteries 7 when needed.

Those skilled in the art will recognize that when multiple types of use are required, such as a trip involving aircraft, boats, trains, buses, cars, etc., the rental package may include both portable massager 1, a battery 7, a connector for power outlets, the voltage converter to allow the portable massager should be attached to either an AC or DC power source, and a special-purpose adapter, such as a power plug that attaches to automobile cigarette lighters.

Another alternative method of using the system is the situation where an individual owns their own portable massager 1. In this case, if the user desires to use facility power, which may be necessary during long trips, the facility operator would rent access to the power outlet for a specified event, such as an airplane flight, or a performance at a sporting arena, a concert, etc. This can be accomplished by a mechanical locking mechanism on the power outlet, for the use of a specially configured our adapter cable, or preferably by activating the power output remotely. Yet another alternative method, for those users desiring to use their own portable massager 1, is to rent batteries for attachment to the portable massager 1. This is useful in the situation where the user is taking a long trip, and the battery 7 would drain prior to completion of the trip.

The massage device presented herein can be used in many environments, including airports, aircraft, trains, process, automobiles, wheelchairs, hospital beds, and parks, sports arenas, concert halls, etc. It can be used by, pilots, stewardesses, drivers, passengers, etc. It can be rented by a service provider such that the user does not have the burden of carrying the portable massager from place to place. Alternatively, the device can be carried by a user from one venue to another. A battery can be used to provide the user with more freedom as to where the device will be used. Without the use of the battery, a conventional power cord can be used to deliver power to the device. In this situation, the facility operator may rent a battery to a user, or charge the user to attach the user's device to the power output in the facility.

In addition to the direct benefit provided to users of the portable massagers, the distribution system disclosed herein also allows transportation carriers, public event facilities, and other service providers to augment the revenue generated by their primary service activities. For example, in highly competitive industries, such as air travel, the level of competition is forced the individual companies to work with thin profit margins. By using this system, the aircraft industry can achieve multiple benefits. First, the customers will be more comfortable and satisfied the flight experience. Second, the system provided herein improves the cash flow to the airline through the rental of the portable massagers. Because these devices are durable and long-lasting, it will provide substantial profit margin to any provider, whether they be an airline, a bus line, a rental car company, a sports Arena, a wheelchair rental service, etc. In the example given of an airline, the airline will not only increase its cash flow, but the convenience provided by the ability of the traveler to rent a portable massager will increase the probability that the traveler will decide to use that airline again in the future.

An additional benefit to the user is that the massager service can be combined with other programs, such as frequent-flier plans on airlines, wherein the individual can use the portable massager by using some earned “frequent-flier points” from their frequent-flier program. This reduces the airline's frequent-flier obligations, while making the massage service more attractive because cash does not have to change hands. Many other merchants, in addition to Airlines, provide customers with “earned points” which of the equivalent of frequent-flier points. In the preferred embodiment, the airlines would be able to accept payment from any authorized merchants that provides their customers with earned points. This would be an additional incentive for the individual to rent the portable massager, and would improve cash flow into the airline or other service provider.

In addition to the rental of the device for a single vendor, such as a particular airline, the device can be rented for use with the facilities of multiple vendors. In that case, the other vendors could also charge for provision of power or batteries. This was the case above, payment can be made by cash, cash equivalents, were earned points.

While the invention has been described with respect to a preferred embodiment thereof, it will be understood by those skilled in the art that various changes in detail may be made therein without departing from the spirit, scope, and teaching of the invention. For example, the material used to construct the support surface may be anything suitable for its purpose, the size and shape of the support surface can vary. The type of battery can vary, etc. Accordingly, the invention herein disclosed is to be limited only as specified in the following claims.

What is claimed is:

1. A method of providing therapeutic massage to travelers, including the steps of:
renting, for a predetermined period of time, a portable massaging device which has a support surface, comprising an external cover, a plurality of massage elements disposed inside the external cover, a controller to control the massage elements; and
providing means to power the plurality of massage elements.

2. A method, as the claim 1, including the additional step of:
providing a common connector that can be used to connect to one or more types of power sources.

3. A method, as in claim 2, including the additional step of:
powering the portable massaging device by attaching a battery to the common connector.

4. A method, as in claim 3, including the additional step of:
securing the battery and a sleeve or pocket in the portable massage device.

5. A method, as in claim 3, including the additional step of:
rolling up, or folding, the portable/device such that it may be stored in the minimum amount of space when not in use.

6. A method, as in claim 2, including the additional step of:
powering the massaging device by attaching a cable from a fixed location power outlet to the common connector.

7. A method, as in claim 6, including the additional step of:
enabling the fixed location power outlet for a predetermined period of time, after payment has been made.

8. A method, as a claim 7, including the additional step of:
enabling the fixed location power outlet from a remote location.

9. Method, as including 7, including the additional steps of:
mechanically enabling the fixed location power outlet.

10. A method, as in claim 1, including the additional steps of:
providing the portable massage device to an individual at a first preselected location; and
retrieving the portable massage device from the individual at a second preselected location.

11. A method, as in claim 10, including the additional steps of:
using the portable massager in multiple locations, for on multiple transportation vehicles over a predetermined time period.

12. A method, as in claim 10, including the additional step of:
accepting payment for rental of the portable massage device from the individual in the form of cash, cash equivalents, or earned points.

13. A portable therapeutic massage device, further comprising:
an external cover;
a plurality of massage elements disposed inside the external cover
a controller to control the massage elements; and
a quick disconnect power connector for inputting power to the massage elements from multiple sources, including a battery or power from a cable attached to a fixed power outlet.

14. A device, as in claim 13, further comprising:
means to convert the power frequency and voltage from that supplied by the fixed power outlet to voltage suitable for the massage elements.

15. A device, as in claim 13, further comprising:
a battery sleeve to removably secure the battery to the external cover, the sleeve having at least one opening to receive the battery, means to secure the battery in the battery sleeve, and an electrical connector and connect the battery to the quick disconnect power connector.

16. A device, as in claim 13, further comprising:
at least one retaining strap and quick release clip;
the portable massage device further having a flexible structure that allows it to be rolled into a closed configuration having a distal and proximal end; and
the at least one retaining strap and quick release clip sized such that when secured to the portable massage device in the closed configuration, it prevents the portable massage device from leaving the closed configuration.

17. A device, as in claim 16, further comprising:
a shoulder strap attached to the distal and proximal ends of the portable massage device such that the shoulder strap extends upward from the portable massage device.

1. A method of providing therapeutic massage to travelers, including the steps of:
using a reservation system to control access to a therapeutic massage device, for a predetermined period of time, and for a predetermined number of travel carriers, and/or event facilities, and/or service providers, and/or providers of accommodations;
entering a series of rentals of multiple devices, or rental of a single device, into the reservation system, and communicating with other travel carriers, and/or event facilities, and/or service providers, and/or providers of accommodations instructions as to the provision of the therapeutic massage device.

19. A method, as in claim 18, including the additional step of:
providing payment for the therapeutic massage device by using frequent-flier points, or other credits, as payment to reservation system.

20. A method, as in claim 19, including the additional steps of:
providing the portable massage device to an individual at a first preselected location; and
retrieving the portable massage device from the individual at a second preselected location.
